(19) United States
(12) Patent Application Publication
(10) Pub. No.: US 2006/0033336 A1
(43) Pub. Date: Feb. 16, 2006

(54) Weld-free connectors for structural elements

(75) Inventor: Mark D. Pulver, Chittenango, NY (US)

Correspondence Address: WALL MARJAMA & BILINSKI, 101 SOUTH SALINA STREET, SUITE 400, SYRACUSE, NY, 13202, US

(73) Assignee: Syracuse Castings Sales Corporation, Cicero, NY (US)

(21) Appl. No.: 11/201,928

(22) Filed: Aug. 11, 2005

Related U.S. Application Data
(60) Provisional application No. 60/600,622, filed on Aug. 11, 2004.

(51) Int. Cl. F16L 21/00

(52) U.S. Cl. 285/417

(57) ABSTRACT

Weld-free connections and connectors and methods of forming such connections and connectors are provided wherein first and second members are positioned so as to create a joint region and a cavity, and wherein the cavity is filled with a polymeric material that adheres to at least the joint region to form a weld-free connection or connector once the polymeric material has cured.

### CROSS-REFERENCE TO RELATED APPLICATION(S)

This application claims priority from and incorporates by reference the entirety of U.S. Provisional Patent Application Ser. No. 60/600,622, which was filed on Aug. 11, 2004.

### FIELD OF THE INVENTION

The present invention relates to methods and apparatus for forming connections within structural elements, and, in particular, to weld-free connectors and connections within overhead roadway signage and structures and methods of forming such connectors/connections.

### BACKGROUND OF THE INVENTION

Motorists rely upon roadway signage and structures to receive important information (e.g., information regarding highway exits, distances to approaching municipalities, gas-food-lodging, traffic conditions) and to ensure their safety (e.g., via traffic signals, light poles, warning beacons). To guarantee maximum visibility, these structures are often very large and are constructed such that they overhang the roadway. Thus, there could be significant adverse consequences (e.g., fatalities, damage to vehicles and/or roadways, increased traffic) if the structures were to fall.

At present, the majority of overhead roadway structures utilize one or more welded metal connections. For example, a cantilevered overhead roadway structure (e.g., a light pole) generally utilizes two or more welded metal connections, including at least one connection between the base plate and the vertical column and at least one connection between the vertical column and the horizontal mast. These welded connections are vulnerable to fatigue-based failure due to the natural stresses placed thereupon, the aging of the materials from which they are constructed, and the effects of precipitation (e.g., rain, snow), harmonic vibration (due to, e.g., galloping, natural wind gusts, and “truck” gusts from passing motor vehicles), and human intervention (e.g., road salt used to treat snow and ice, leaked antifreeze, vandalism).

Those who design overhead roadway signage and structures have developed or made use of design methodologies to estimate when such structures may undergo failure. However, the resultant designs are not guaranteed to be accurate, mostly due to the inability to precisely estimate the many conditions, especially the fatigue characteristics of welded joints. This is because welding induces highly variable residual stresses, which, in turn, can cause premature fatigue-based failure. Also, welded designs can be subject to fatigue-based failure at stress levels much lower than would be anticipated based on the strength of the materials being welded. Moreover, conditions such as runaway galloping caused by site-sensitive harmonic vibration can in turn cause a structure to undergo catastrophic failure well in advance of a predicted date. And even when such design methodologies are ultimately accurate, those who oversee the structures still must be trusted to repair and/or replace the structures in accordance with the schedule dictated by the models, otherwise tragedy may occur. Thus, those in the art understood there was a need to extend the lifetime of overhead roadway structures, with the logic being that the longer the structures remain standing, the more likely it will be that someone takes appropriate measures in time to prevent an anticipated or catastrophic failure from occurring.

One attempt to meet this need has been via implementation of so-called “weld-free” connectors. For example, U.S. Pat. No. 6,685,154 B1 to Blyth et al. (the entirety of which is incorporated by reference herein), teaches weld-free connectors for use in erecting light poles and the like. In an embodiment of the Blyth et al. patent, a first connector is provided to join a tapered column to a base and a second connector is further provided to join a tapered mast to the tapered column. The joint regions between the connectors and the structural elements are closed in assembly. In addition, torsion bars such as bolts or pins are pasted through the joints to provide torque resistance. Lastly, neoprene pads are placed in the joint regions in order to provide vibration dampening.

Although use of the Blyth et al. weld-free connectors in place of traditional welded connections may increase the lifetime of the structures in which they are used, installation of such connectors has proven to be quite difficult and time-consuming, so much so that those entrusted with building, purchasing and installing overhead roadway structures have not sought to implement them on a widespread basis.

Therefore, a need exists for weld-free connectors/connections that can be utilized to extend the lifetime of overhead roadway structures without necessitating added cost or complexity in their implementation.

### SUMMARY OF THE INVENTION

These and other needs are met by the present invention, which provides weld-free connectors for connecting two or more members or elements, as well as methods for forming such weld-free connectors. Despite being weld-free, the connectors formed in accordance with the present invention provide excellent vibration dampening and are highly resistant to fatigue-based cracking and failure. Such weld-free connections can be advantageously substituted for welded connections within roadway signage and other structures in order to prevent or delay fatigue-based cracking and failure caused by stresses and harmonic vibrations that occur due to, e.g., galloping, natural wind gusts and so-called truck gusts.

In accordance with an exemplary aspect of the present invention, a non-welded (i.e., weld-free) connector for joining a plurality of structural members includes at least a first and second members, wherein the first member is in tactile communication with the second member to define a joint region. A sleeve is positioned around (e.g., substantially centered over) the joint region of the first and second structural members to define a cavity between the sleeve and at least the joint region of the first member and the second member. A predetermined quantity of polymeric material is introduced within the cavity, and adheres to at least the joint region of the first and second members. The cavity is sealed so as to contain the polymeric material, which, once cured, forms a weld-free connection/connector at the joint region.

In accordance with another exemplary aspect of the present invention, a non-welded connector for joining a plurality of structural members includes at least a first member and a second member, wherein a portion of the first member is disposed at least partially within a portion of the second member so as to be in tactile communication with the first member at a joint region. The first member has a diameter less than that of the portion of the second member in which the portion of the first member is disposed, so as to define a cavity between the first member and the second member. A predetermined quantity of polymeric material is introduced within the cavity, wherein the polymeric material adheres to at least the joint region of the first and second members so as to provide a weld-free connection once the polymeric material has cured.

In accordance with yet another exemplary aspect of the present invention, a non-welded connector for joining a plurality of structural members, includes at least a first member and a second member, wherein a portion of the first member is disposed at least partially within a portion of the second member so as to be in tactile communication with the first member. The first member has a diameter less than the portion of the second member in which the portion of the first member is disposed so as to define a cavity between the first member and the second member. An object (e.g., a split ring) is in tactile communication with the first member and the second member to define a joint region between the first member and the second member. A predetermined quantity of polymeric material is introduced within the cavity, wherein the polymeric material adheres to at least the joint region of the first and second members so as to provide a weld-free connection once the polymeric material has cured.

In accordance with these exemplary aspects (and, if desired, still other aspects) of the present invention, the first member and the second member (and, if present, the sleeve) can be made of the same material or a different material, wherein suitable such materials, by way of non-limiting example, can be metal-based materials such as iron, steel and aluminum.

In accordance with these exemplary aspects (and, if desired, still other aspects) of the present invention, the polymeric material is selected in order to provide such properties as proper adhesion, excellent vibration dampening, torsion resistance, and/or fatigue resistance. By way of non-limiting example, the polymeric material can be a polyurethane material, e.g., an unpigmented polyurethane comprised of a predetermined ratio of a resin and an isocyanate.

In accordance with another exemplary aspect of the present invention, a cantilevered structure (e.g., a light pole, a traffic signal) is provided and includes a base, a substantially vertically disposed column that is connected to the base (e.g., by a flange through use of at least one fastener), and a substantially horizontally disposed mast. The column has a predetermined height and can be made of a predetermined material (e.g., iron), and the mast has a predetermined length and can be made of a predetermined material (e.g., aluminum). Either or both the mast and the column can have substantially constant or tapered diameters.

One or more non-welded connections can be formed within the cantilevered structure. For example, a first non-welded connection can be provided between the vertical section of the base and the column, and can be formed of a predetermined quantity of a first polymeric material within a first cavity defined between the vertical section of the base and the column. A second non-welded connection can be provided between the column and a vertically disposed sleeve that surrounds at least a portion of the column, and can be formed of a predetermined quantity of a second polymeric material (e.g., the same or different polymeric material as the first polymeric material) within a second cavity defined between the vertical sleeve and the column. An optional third non-welded connection can be provided between the mast and a horizontally disposed sleeve that is orthogonal to the column and-that surrounds at least a portion of the mast, and can be formed of a predetermined quantity of a third polymeric material (e.g., the same or different polymeric material as the first polymeric material and/or the second polymeric material) within a third cavity defined between the horizontal sleeve and the column. If the third weld-free connection is not included, it can be replaced by one or more other connections known in the art, e.g., a slip fit joint.

Still other aspects, embodiments and advantages of the present invention are discussed in detail below.

### BRIEF DESCRIPTION OF THE DRAWINGS

For a fuller understanding of the nature and desired objects of the present invention, reference is made to the following detailed description taken in conjunction with the accompanying figures, wherein like reference characters denote corresponding parts throughout the views, and in which:

FIG. 1 is side elevational view, in section, illustrating a weld-free connection in accordance with an exemplary embodiment of the present invention;

FIG. 1A is a side elevational view, in section, illustrating a first alternate embodiment of the weld-free connection of FIG. 1;

FIG. 1B is a side elevational view, in section, illustrating a second alternate embodiment of the weld-free connection of FIG. 1;

FIG. 2 is a side elevational view, in partial section, illustrating a cantilevered structure having a plurality of weld-free connections in accordance with the present invention;

FIG. 3 is an enlarged, side sectional view illustrating a first weld-free connection of FIG. 2; and

FIG. 4 is an enlarged, side elevational view in partial section illustrating a second weld-free connection of FIG. 2 as well as an optional third weld-free connection of FIG. 2.

### DETAILED DESCRIPTION

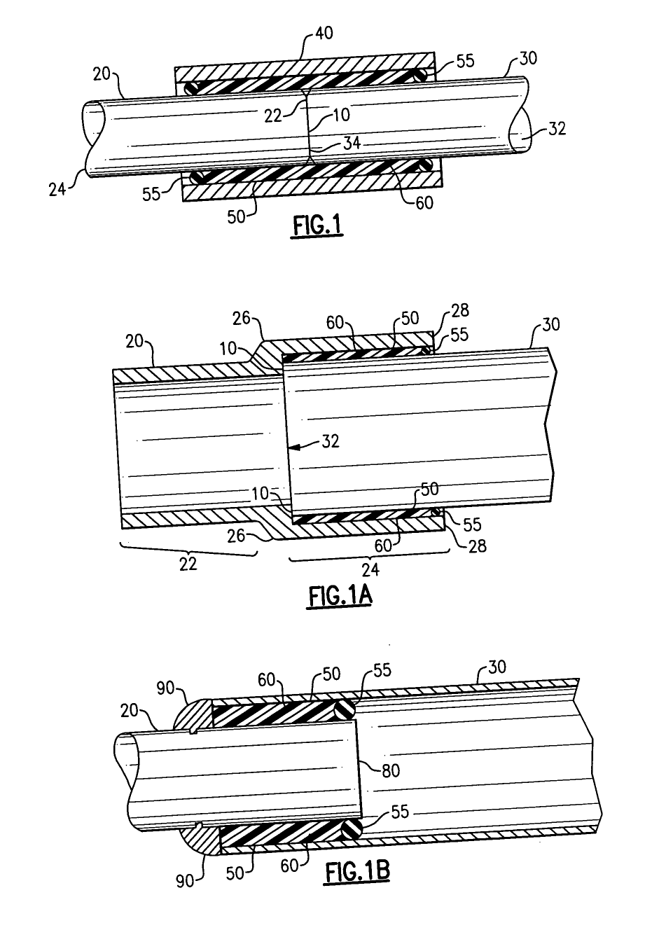

Referring initially to FIG. 1, there is illustrated an exemplary weld-free connection/connector in accordance with the present invention wherein a first member or element 20 and a second member or element 30 have been effectively connected to each other—without the use of welding—to form a joint 10. First and second members 20, 30 can have any size and shape, as dictated, e.g., by design choice or user preference. Generally, the first and second members 20, 30 are similarly shaped and sized; however, that is not a requirement of the present invention.

The first member 20 has a first end 22 and a second end 24, and the second member 30 has a first end 32 and a second end 34. Prior to being joined together, the first member 20 and the second member 30 are placed in tactile communication. According to an exemplary embodiment of the present invention, and as shown in FIG. 1, this occurs by positioning the first end 22 of the first member 20 and the second end 34 of the second member 30 such that those ends are abutting.

The abutting first and second members 20, 30 are then placed within a surrounding sleeve 40. The sleeve 40 is positioned with respect to the abutting members 20, 30 such that at least a portion of the sleeve surrounds at least a portion of each of the first and second member, thus, in turn, ensuring that the sleeve will surround at least the abutting ends 22, 34 of the first and second members. According to an exemplary embodiment of the present invention, and as depicted in FIG. 1, the sleeve 40 is substantially cylindrical and is substantially centered over the abutting members 20, 30, wherein substantially equal portions of the sleeve surround the first and second members.

In accordance with an alternate embodiment of the present invention, the first and second members 20, 30 are positioned such that their ends 22, 34 are not abutting, but instead are in close proximity. As with the exemplary embodiment described above, however, the non-abutting ends 22, 34 generally are surrounded by the sleeve 40.

The first and second members 20, 30 and the sleeve 40 can be made of the same or different materials; however, in an exemplary embodiment of the present invention, the first member, the second member and the sleeve are formed of the same metal-based material, wherein suitable such materials include, but are not limited to iron, steel and aluminum.

As shown in FIG. 1, and in accordance with an exemplary embodiment of the present invention, the first and second members 20, 30 have substantially similar diameters and the surrounding sleeve 40 has a diameter larger than that of the abutting first and second members, thus defining a cavity 50 between the members and the sleeve. The diameter of the sleeve 40 will vary depending on the size and shape of the first and second members 20, 30, which also can vary. Therefore, the distance between the sleeve and the first and second member 20, 30 (i.e., the diameter/width of the cavity 50 ) can vary as well.

The cavity 50 is sealed at each end as is known in the art, e.g., through use of a plugging object 55 such as an O-ring made of silicone, rubber, a thermoplastic resin, or a thermoset resin, or through use of weather stripping, or via a chemical sealant. Alternatively, one or more of the O-ring seals 55 can be formed integral with the sleeve 40. A predetermined quantity of polymeric material 60 is introduced within the sealed cavity and allowed to cure to form the non-welded connection at the joint 10. This can occur as is generally known in the art, e.g., by pumping, injecting or otherwise introducing the polymeric material into the cavity 50 through an injection port (not shown). A second port (not shown) can be provided away from the injection port in order to assess when the cavity 50 is full—that is, the polymeric material 60 is introduced until it starts to emerge from the second port, thus indicating that the cavity has been completely or at least substantially filled with the polymeric material.

The specific choice of polymeric material 60 for filling the cavity 50 can vary according to several factors, including, but not limited to the chosen materials for first and second members 20, 30, the width of the cavity 50, the diameter of the members, and the purpose for joining the first and second members. Generally, the chosen polymeric material 60 has at least one of the following materials properties: proper adhesion when used in association with a wide range of materials; excellent vibration dampening properties; torsion resistance; lack of susceptibility to degrading conditions (e.g., road salt, antifreeze); and fatigue resistance even when subjected to high vibrational loads. Polymeric materials exhibiting such properties include, but are not limited to urethane materials, such as polyurethane. An exemplary polyurethane material is unpigmented polyurethane comprised of a resin and an isocyanate. By way of non-limiting example, the polyurethane material 60 can be comprised of about 100 parts of a resin commercially available from BASF Corporation of Florham Park, N.J. USA under supply part number NB # 98113-1-256-212 and about 94.3 parts of an isocyanate commercially available from BASF Corporation of Florham Park, N.J. USA under supply part number WVC 3154T. In its cured form, this polyurethane material exhibits the following materials properties:

| Index | | 105 |
|---|---|---|
| Hardness, Shore D/Shore A | | 65/95 |
| Tensile Strength, (psi) | | 4150 |
| Elongation, (%) | | 185 |
| Tear Strength, Graves (pli) | | 830 |
| Notched Izod Impact (ft.-lb./in.) | | 12.1 |
| Flexural Modulus (psi) | @ −20° F. | 104,000 |
| | @ 72° F. | 55,000 |
| | @ 158° F. | 28,000 |

As the polymeric material 60 is introduced within the cavity 50, it surrounds the first and second members 20, 30, including at their abutting ends 22, 34. Thus, once the polymeric material 60 cures, it will adhere to the first and second members 20, 30, and, in turn, will cause the members to be maintained within their abutting position through a weld-free connection/connector created at joint 10.

Although not shown in FIG. 1, more than two members or elements can be connected in this manner to form a plurality of joints through use of weld-free connections/connectors of the present invention. For example, prior to introduction of the polymeric material 60, a third member (not shown) can be placed in tactile communication with the second member 30 such that an end of the third member abuts the first end 32 of the second member and a fourth member (not shown) can be placed in tactile communication with the first member 20 such that an end of the fourth member abuts the second end 24 of the first member. In accordance with such an embodiment, three joints (each of which is surrounded by a sleeve 40 ) would be formed once the polymeric material 60 has been introduced into and cured within the cavity 50: the aforementioned joint 10 formed between the first and second members 20, 30, another joint (not shown) formed between the second and third members, and yet another joint (not shown) formed between the first and fourth members, wherein each joint is a weld-free connection/connector. Still more members or elements can be joined in this manner through use of weld-free connectors/connections of the present invention, wherein each added member increases the overall length of the joined members and wherein the total number of joints is generally equal to one less than the total number of joined members.

Thus, the present invention provides an important advantage, namely the ability to tailor the length of a plurality of joined members or elements through use of weld-free connections. For example, it is a well known problem in the art that certain types of ductile iron piping are only available in lengths which restrict their use to a limited number of structural applications. However, in accordance with an exemplary embodiment of the present invention, several individual segments of iron piping can be joined via weld-free connections/connectors to form what is in essence a single, joined piece of piping having a tailored length as needed for a particular structural application. That, in turn, will beneficially expand the number of structural applications for ductile iron piping. Moreover, the presence of the polymeric material within the weld-free connections provides highly advantageous shock, blast and earthquakes resistance, plus excellent vibration dampening characteristics.

Referring now to FIG. 1A, an alternate embodiment of the weld-free connection/connector of FIG. 1 is shown. FIG. IA depicts a first member 20 and a second member 30, wherein the first member has a first section 22 having a first diameter and a second section 24 having a second, larger diameter. The first section 22 of the first member 20 transitions to the second section 24 at a junction area 26. The second member 30 is inserted within the larger diameter section 24 of the first member 20 such that an end 32 of the second member abuts the junction area 26. The second member 30 has a diameter less than that of the second section 24 of the first member 20, thus defining a cavity 50 between the second member and the second section of the first member. The cavity 50 is sealed via one or more seals 55 (e.g., one or more O-rings) or through the use of sealant between the second member 30 and the end 28 of the second section of the first member 20. Polymeric material 60 is introduced within the sealed cavity (e.g., as described above with respect to FIG. 1) so as to create a joint 10 at the junction area 26 between the first member 20 and the second member 30.

Referring now to FIG. 1B, another alternate embodiment of the weld-free connection/connector of FIG. 1 is shown. In this instance, a first member 20 having a predetermined diameter is placed at least partially within a second member 30 having a larger diameter, thus defining a cavity 50 between the first member and the second member. One or more seals 55 (e.g., one or more O-rings) or sealants are placed between the first member and the second member at the end 80 of the first member that is within the second member. Polymeric material 60 is introduced (e.g., as described above with respect to FIG. 1) within the sealed cavity 50, which is then further sealed by placing an object 90 in communication with the first member 20 and the second member 30, as shown in FIG. IB. In accordance with an exemplary embodiment of the present invention, the object 90 is a split ring, which can be fastened to the first and second members 20, 30 or supported by a groove, pins or bolts as is generally known in the art, and which provides a joint between the first and second members.

The embodiments depicted in FIGS. 1A and 1B provide still further design flexibility in addition to the FIG. 1 embodiment. For example, the embodiment depicted in FIG. 1A provides design flexibility if it is desired to connect bell piping to other piping, and the FIG. 1B embodiment provides design flexibility if it is desired to join piping having non-uniform (e.g., stepped) diameters. Moreover, the techniques and arrangements depicted in FIGS. 1, 1A and 1B can be combined, as desired, to join multiple structural members in accordance with the present invention, thus providing still more design flexibility.

The weld-free connections/connectors of the present invention have important uses in practice, including, by way of non-limiting example, replacing traditional welded connections/connectors in certain structures. For example, weld-free connections/connectors of the present invention can be incorporated within roadway structures and signage having cantilever, butterfly or bridge support (i.e., overhead or span-type support) designs, or still other designs. Examples of such roadway structures and signage include, but are not limited to, light poles, highmast luminaries, traffic signal structures, overhead highway signs, and mounted traffic monitoring equipment. Also, the weld-free connections can be beneficially incorporated within any structures (e.g., bridges, buildings) that require increased shock, blast and/or earthquake resistance.

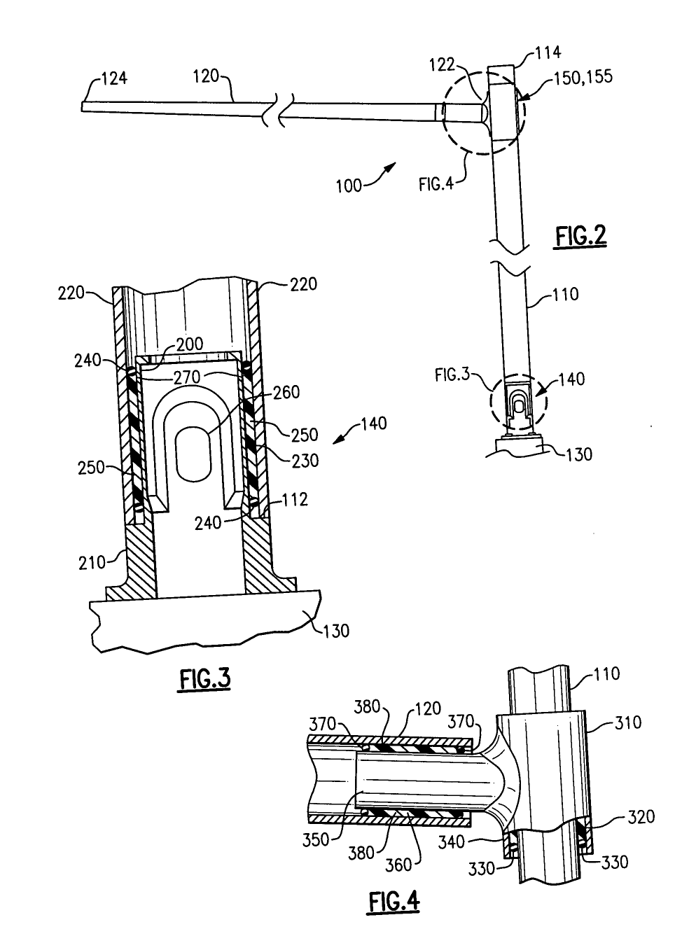

An exemplary cantilevered light pole 100 is shown in FIG. 2, wherein weld-free connections/connectors in accordance with the present invention have replaced one or more of the welded connections/connectors that are traditionally utilized within the cantilevered light pole. The cantilevered light pole 100 of FIG. 2 has a vertically disposed cylindrical column 110, which supports a horizontally disposed hollow mast 120. The pole 100 includes a first weld-free connection 140, as illustrated in FIG. 3 and as will be described in detail below, and a second weld-free connection/connector 150, as illustrated in FIG. 4 and as will be described in detail below, and an optional third weld-free connection/connector 155, as illustrated in FIG. 4 and as also will be described in detail below.

The column 110 has a first end 112 (see FIG. 3), which is in closest proximity to the base 130, and a second, opposing end 114. The mast 120 has a first end 122, which is in closest proximity to the column, and a second, opposing end 124. Optionally, the column 110 has a diameter that tapers from its first end 112 to its second end 114 and the mast 120 has a diameter that tapers from its first end 122 to its second. By way of non-limiting example, the rates of taper for the diameter of the column 110 and mast can be about 0.10 inch/foot and about 0.14 inch/foot, respectively. The taper can be constant or non-constant (e.g., stepped). For example, the 0.14 inch/foot diameter taper for the mast 120 can be achieved though a constant taper or, instead, by reducing the diameter of the mast by about 2 inches at 15 feet stepped increments along the length of the mast.

The column 110 and the mast 120 of the light pole 100 can be made of the same material or a different material, wherein suitable materials from which the column and the mast can be made include, but are not limited to, metal-based materials such as iron, steel and aluminum. In accordance with an exemplary embodiment of the present invention, the column 110 is made of an iron material because iron is stronger in compression than tension, and the mast is made of an aluminum material because aluminum is a lightweight metal-based material but also has an excellent strength to weight ratio. Moreover, without wishing to be bound by theory, it is believed that the presence of the polymeric material within the weld-free connections/connectors that are included within the light pole 100 will beneficially reduce the possibility of a galvanic reaction occurring between the iron and the aluminum.

FIG. 3 illustrates in added detail the first weld-free connection/connector 140 of the light pole 100 of FIG. 2, wherein the connection/connector 140 is made between the base 130 and the column 110. A base casting includes a vertical section 200 and a flanged portion 210. Generally, the vertical section 200 and flanged portion 210 of the base casting are made from the same or different relatively high strength materials in order to create a high strength connected body. In an exemplary embodiment of the present invention, the vertical section 200 and the flanged portion 210 of the base casting are made of the same metal-based material, wherein suitable such materials include, but are not limited to iron, steel, and aluminum.

The flanged portion 210 of the base casting is connected to the base 130 by a technique that ensures a reliable and secure connection. According to an exemplary embodiment of the present invention, the flanged portion 210 is connected to the base 130 by a fastening technique (e.g., embedment), through the use of concrete, or via a bolted connection, each as is generally known in the art.

To form the weld-free connection/connector 140 between the column 110 and the base 130, a space or cavity 230 is defined between the inner walls 220 of the column 110 and the outer walls 270 of the vertical section 200 of the base casting. One or more seals 240 (e.g., one or more O-rings) are mounted within the cavity 230, e.g., in the upper and lower parts of the cavity as shown in FIG. 3. The sealed cavity is filled (e.g., as described above with respect to FIG. 1) with a polymeric material 250 (e.g., a polyurethane material as described above), which, once cured, creates a weld-free connection/connector 140 between the column 110 and the vertical section 200 of the base casting. Thus, due to the fact that the vertical section 200 of the base casting is connected to the base 130 via the flanged portion 210 of the base casting, the weld-free connection/connector 140 between the column 110 and the base casting effectively connects the column and the base 130.

As illustrated in FIG. 3, and in accordance with an exemplary embodiment of the present invention, a hand hole 260 is formed in an area where the column 110 overlaps the base 130. This placement of the hand hole 260 is beneficial in that reduces the height (and, thus, the overall weight) of the column 110 yet still serves to protect the column from fatigue-based failure caused by notch sensitivity.

Turning now to FIG. 4, a second weld-free connection 150 and an optional third weld-free connection 155 of the light pole 100 of FIG. 2 are illustrated in added detail. For the second weld-free connection 150, a vertically disposed sleeve 310 is arranged to surround the column 110 so as to enable the sleeve to be slideably moved into a desired position along the vertical length of the column. A first space or cavity 320 is provided or defined between the sleeve 310 and the column 110, and one or more appropriate seals (e.g., one or more O-rings) or closure devices 330 are provided (e.g., mounted at the upper and lower ends of the cavity) in order to enclose the first cavity. The enclosed first cavity or space 320 is filled (e.g., as explained above with respect to FIG. 1) with a polymeric material 340 (e.g., a polyurethane material as described above), which, once it has cured, provides a secure fatigue resistant joint between the column 110 and the vertically disposed sleeve 310, wherein this joint acts as the second weld-free connection/connector 150 for the light pole 100.

For the optional third weld-free connection 155, a horizontally disposed sleeve 350 is positioned substantially orthogonal to the vertical column 110 in order to slideably receive the open end of the mast 120. A second space or cavity 360 is provided or defined between the mast 120 and sleeve 350, and one or more appropriate seals (e.g., one or more O-rings) or closure devices 370 are provided (e.g., mounted at the upper and lower ends of the cavity) to enclose the second cavity. The enclosed second space or cavity 360 is then filled (e.g., as explained above with respect to FIG. 1) with a polymeric material 380 (e.g., a polyurethane material as described above), which, once it has cured, provides a secure fatigue resistant joint between the mast 120 and the horizontally disposed sleeve 350, wherein this joint acts as the third weld-free connection/connector 155 and further provides the light pole 100 with high resistance to fatigue that might be cased by naturally induced vibrations.

Although the mast 120 in the FIG. 4 embodiment of the present invention is depicted as overlying the horizontal sleeve 350, it should be understood by one of ordinary skill in the art that the mast can be similarly slideably received within the sleeve without departing from the teachings of the present invention. Moreover, in accordance with an exemplary embodiment of the present invention, the optional third weld-free connection 155 is not included within the light pole 100. In such an embodiment, the optional third weld-free connection 155 can be replaced by one or more other connections known in the art, including, but not limited to, a slip joint fit.

Although the present invention has been described herein with reference to details of currently preferred embodiments, it is not intended that such details be regarded as limiting the scope of the invention, except as and to the extent that they are included in the following claims—that is, the foregoing description of the present invention is merely illustrative, and it should be understood that variations and modifications can be effected without departing from the scope or spirit of the invention as set forth in the following claims. Moreover, any document(s) mentioned herein are incorporated by reference in their entirety, as are any other documents that are referenced within the document(s) mentioned herein.

What is claimed is:

1. A non-welded connector for joining a plurality of structural members, comprising:
at least a first member and a second member, wherein the first member is in tactile communication with the second member to define a joint region of the first member and the second member
a sleeve positioned around at least the joint region of the first and second structural member to define a cavity between the sleeve and at least the joint region of the first member and the second member; and
a predetermined quantity of polymeric material within the cavity, wherein the polymeric material adheres to at least the joint region of the first and second members.

2. The non-welded connector of claim 1, further comprising at least one seal for sealing the cavity.

3. The non-welded connector of claim 2, wherein the each of the first member, the second member and the sleeve is made of a metal-based material selected from the group consisting of iron, steel and aluminum.

4. The non-welded connector of claim 1, wherein the sleeve is substantially centered over the joint region.

5. The non-welded connector of claim 1, wherein the polymeric material is a polyurethane material.

6. The non-welded connector of claim 5, wherein the polyurethane material is an unpigmented polyurethane.

7. The non-welded connector of claim 6, wherein the unpigmented polyurethane is comprised of a resin and an isocyanate.

8. A non-welded connector for joining a plurality of structural members, comprising:
at least a first member and a second member, wherein a portion of the first member is disposed at least partially within a portion of the second member so as to be in tactile communication with the first member at a joint region between the first member and the second member, the first member having a diameter less than the portion of the second member in which the portion of the first member is disposed so as to define a cavity between the first member and the second member; and
a predetermined quantity of polymeric material within the cavity, wherein the polymeric material adheres to at least the joint region of the first and second members.

9. A non-welded connector for joining a plurality of structural members, comprising:
at least a first member and a second member, wherein a portion of the first member is disposed at least partially within a portion of the second member so as to be in tactile communication with the first member, the first member having a diameter less than the portion of the second member in which the portion of the first member is disposed so as to define a cavity between the first member and the second member;
an object in tactile communication with the first member and the second member to define a joint region between the first member and the second member; and
a predetermined quantity of polymeric material within the cavity, wherein the polymeric material adheres to at least the joint region of the first and second members.

10. The non-welded connector of claim 9, wherein the object is a split ring.

11. A method of forming at least one weld-free connection between a plurality of structural members, comprising the steps of:
providing at least a first member and a second member, wherein each member has a first end and a second end;
positioning the first and second member such that at least one of the first end and the second end of the first member is in tactile communication with one of the first end and the second end of the second member to define a joint region of the first member and the second member;
placing a sleeve around at least the joint region of the first member and the second member to define a cavity between the sleeve and at least the joint region of the first member and the second member; and
introducing a predetermined quantity of a polymeric material within the cavity such that the polymeric material adheres to at least the joint region of the first and second members.

12. The method of claim 11, further comprising the step of sealing the cavity.

13. A cantilevered structure, comprising:
a base having a vertical section;
a column having inner and outer walls;
a casting connected to the base and including a vertical section having inner and outer walls, the casting being positioned so as to define a first cavity between the outer walls of the vertical section of the casting and the inner walls of the column;
a first non-welded connection, the first non-welded connection being between the casting and the column and being formed of a predetermined quantity of a first polymeric material within the first cavity;
a substantially horizontally disposed mast, comprising:
a vertically disposed sleeve surrounding at least a portion of the column so as to define a second cavity therebetween; and;
a horizontally disposed sleeve orthogonal to the column and surrounding at least a portion of the mast so as to define a third cavity therebetween; and
a second non-welded connection, the second non-welded connection being between the vertically disposed sleeve and the column and being formed of a predetermined quantity of a second polymeric material within the second cavity.

14. The cantilevered structure of claim 13, further comprising a third non-welded connection, the third non-welded connection being between the horizontally disposed sleeve and the mast and being formed of a predetermined quantity of a third polymeric material within the third cavity.

15. The cantilevered structure of claim 13, wherein the casting further includes a flanged portion, and wherein the flanged portion is connected to the base.

16. The cantilevered structure of claim 13, wherein each of the first polymeric material, the second polymeric material and the third polymeric material is a polyurethane material.

17. The cantilevered structure of claim 13, wherein each of the first cavity and the second cavity is sealed.

18. The cantilevered structure of claim 13, wherein at least one of the column and the mast has a varying diameter.

19. The cantilevered structure of claim 13, wherein the column is made of an iron material and the mast is made of an aluminum material.

20. A cantilevered structure, comprising:
a base having a vertical section;
a column having inner and outer walls;
a casting comprising:
a vertical section having inner and outer walls; and
a flanged portion connected to the base, wherein the casting is positioned so as to define a first cavity between the outer walls of the vertical section of the casting and the inner walls of the column;
a first non-welded connection, the first non-welded connection being between the casting and the column and being formed of a predetermined quantity of a first polymeric material sealed within the first cavity;
a substantially horizontally disposed mast, comprising:
a vertically disposed sleeve surrounding at least a portion of the column so as to define a second cavity therebetween; and;
a horizontally disposed sleeve orthogonal to the column and surrounding at least a portion of the mast so as to define a third cavity therebetween;
a second non-welded connection, the second non-welded connection being between the vertically disposed sleeve and the column and being formed of a predetermined quantity of a second polymeric material sealed within the second cavity; and
a third non-welded connection, the third non-welded connection being between the horizontally disposed sleeve and the mast and being formed of a predetermined quantity of a third polymeric material sealed within the third cavity.
